(19) United States
(12) Patent Application Publication
(10) Pub. No.: US 2020/0335904 A1
(43) Pub. Date: Oct. 22, 2020

(54) TRANSCEIVER MODULE

(71) Applicant: DELTA ELECTRONICS, INC., Taoyuan City (TW)

(72) Inventors: Chen-Mao LU, Taoyuan City (TW); Wen-Ching CHUANG, Taoyuan City (TW); Li-Hua SU, Taoyuan City (TW)

(21) Appl. No.: 16/543,985

(22) Filed: Aug. 19, 2019

(30) Foreign Application Priority Data
Apr. 19, 2019 (CN) 201910316495.1

(51) Int. Cl. H01R 13/627; G02B 6/42

(52) U.S. Cl. CPC H01R 13/6275; G02B 6/4261; G02B 6/4278

(57) ABSTRACT

A transceiver module includes a housing, a latch, a springy sheet, and a pull tab. The latch has a wedging portion and is movably connected to the housing. The springy sheet is disposed between the housing and the latch. The pull tab is connected to the latch. When the pull tab moves from a first pull tab position to a second pull tab position, the pull tab applies a force to move the latch with relative to the housing and to carry the wedging portion to move from a first wedging position to a second wedging position, thereby deforming the springy sheet. When the force applied by the pull tab is removed, the springy sheet pushes the wedging portion to move from the second wedging position to the first wedging position.

### CROSS REFERENCE TO RELATED APPLICATIONS

This Non-provisional application claims priority under 35 U.S.C. § 119(a) on Patent Application No(s). 201910316495.1 filed in People's Republic of China on Apr. 19, 2019, the entire contents of which are hereby incorporated by reference.

### BACKGROUND OF THE INVENTION

### Field of Invention

The present disclosure relates to a transceiver module and, in particular, to a transceiver module with a springy sheet.

### Related Art

In the optical communication products, such as network apparatuses (e.g. hub), at least one transceiver module is configured for transforming the optical signals to the electrical signals. The fiber can connect to the network apparatus through the above-mentioned transceiver module. In order to increase the flexibility of system design and the convenience of repairing, the transceiver module is plugged into a corresponding socket of the communication device. In general, the socket is disposed on the circuit board. In order to define the electrical and mechanical interfaces between the transceiver module and the corresponding socket, various standards have been proposed, such as SFP (Small Form Factor Pluggable) and QSFP (Quad Small Form-factor Pluggable) for 10 GB/s communication rate.

The corresponding socket of the transceiver module is provided with a locking mechanism for firmly locking the transceiver module in the socket when the transceiver module is inserted into the socket and reaches the final position. Therefore, the transceiver module needs to be configured with an unlocking mechanism, so that the locking mechanism can be easily unlocked and the transceiver module can be detached and removed from the socket.

The locking mechanism and unlocking mechanism of the conventional transceiver module are implemented by a spring, which is configured for converting between the lock status and the unlock status of the transceiver module. However, in the case of using the spring for locking or unlocking the transceiver module and the socket, the transceiver module may be unintentionally detached from the socket due to vibration, or the transceiver module may not be properly locked due to the elastic fatigue of the spring. These problems may affect the plug/unplug of the transceiver module and decrease the reliability of the transceiver module and the electronic device.

Therefore, it is desired to provide a transceiver module having higher reliability and capable of being easily locking or unlocking, so that the communication device utilizing the transceiver module can be easily repaired or adjusted, thereby reducing the repairing or adjusting time.

### SUMMARY OF THE INVENTION

An objective of the present disclosure is to provide a transceiver module that can be easily locking or unlocking. Compared with the conventional transceiver module, the transceiver module of this disclosure comprises a springy sheet having a large contact surface for facilitating the adjustment and increasing the reliability of the transceiver module, thereby making the plug and unplug of the transceiver module easier and thus reducing the repairing and/or adjusting time.

The present disclosure provides a transceiver module, which comprises a housing, a latch, a springy sheet, and a pull tab. The latch has a wedging portion and is movably connected to the housing. A first end of the springy sheet is coupled to the housing, and a second end of the springy sheet contacts against the latch. The pull tab is connected to the latch. When the pull tab moves from a first pull tab position to a second pull tab position, the pull tab applies a force to move the latch with relative to the housing and to carry the wedging portion to move from a first wedging position to a second wedging position so as to deform the springy sheet. When the force applied to the latch by the pull tab is removed, the springy sheet pushes the wedging portion to move from the second wedging position to the first wedging position.

In one embodiment, the springy sheet is a flat sheet, a bent sheet, or a curved sheet.

In one embodiment, the first end of the springy sheet is coupled to the housing by interference bonding, locking, wedging, screwing, or injection molding.

In one embodiment, the pull tab is moved from the first pull tab position to the second pull tab position by shifting or rotating.

In one embodiment, the wedging portion comprises a wedging bump, and the wedging bump is disposed at one side of the wedging portion away from the housing.

In one embodiment, the second end of the springy sheet contacts against one side of the wedging portion close to the housing.

In one embodiment, the latch further comprises a protrusion extending from the latch toward the housing, and the second end of the springy sheet contacts against the protrusion of the latch.

The present disclosure also provides a transceiver module, which comprises a housing, a latch, a springy sheet, and a pull tab. The latch has a wedging portion and is movably connected to the housing. A first end of the springy sheet contacts against the housing, and a second end of the springy sheet is coupled to the latch. The pull tab is connected to the latch. When the pull tab moves from a first pull tab position to a second pull tab position, the pull tab applies a force to move the latch with relative to the housing and to carry the wedging portion to move from a first wedging position to a second wedging position so as to deform the springy sheet. When the force applied to the latch by the pull tab is removed, the springy sheet pushes the wedging portion to move from the second wedging position to the first wedging position.

In one embodiment, the springy sheet is a flat sheet, a bent sheet, or a curved sheet.

In one embodiment, the second end of the springy sheet is coupled to the latch by interference bonding, locking, wedging, screwing, or injection molding.

In one embodiment, the pull tab is moved from the first pull tab position to the second pull tab position by shifting or rotating.

In one embodiment, the wedging portion comprises a wedging bump, and the wedging bump is disposed at one side of the wedging portion away from the housing.

In one embodiment, the second end of the springy sheet is coupled to one side of the wedging portion close to the housing.

In one embodiment, the latch further comprises a protrusion extending from the latch toward the housing, and the second end of the springy sheet is coupled to the protrusion of the latch.

The present disclosure further provides a transceiver module, which comprises a housing, a latch, a springy sheet, and a pull tab. The latch has a wedging portion and is movably connected to the housing. The springy sheet is disposed between the housing and the latch. The pull tab is connected to the latch. When the pull tab moves from a first pull tab position to a second pull tab position, the pull tab applies a force to move the latch with relative to the housing and to carry the wedging portion to move from a first wedging position to a second wedging position so as to deform the springy sheet. When the force applied to the latch by the pull tab is removed, the springy sheet pushes the wedging portion to move from the second wedging position to the first wedging position.

In one embodiment, the springy sheet is a flat sheet, a bent sheet, or a curved sheet.

In one embodiment, the pull tab is moved from the first pull tab position to the second pull tab position by shifting or rotating.

In one embodiment, the wedging portion comprises a wedging bump, and the wedging bump is disposed at one side of the wedging portion away from the housing.

In one embodiment, one end of the springy sheet contacts against one side of the wedging portion close to the housing.

In one embodiment, the latch further comprises a protrusion extending from the latch toward the housing, and one end of the springy sheet contacts against the protrusion of the latch.

As mentioned above, the transceiver module of this disclosure comprises a springy sheet, so the transceiver module has higher reliability and can be easily locked or unlocked in the socket. Accordingly, the communication device utilizing the transceiver module can be easily repaired or adjusted, thereby reducing the repairing or adjusting time.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1A is a schematic diagram showing a transceiver module according to a first embodiment of this disclosure;

FIG. 1B is an exploded view of the transceiver module of FIG. 1A;

FIG. 1C is a sectional view of the transceiver module along the line A-A of FIG. 1A, wherein the transceiver module and the socket are in a lock status;

FIG. 1D is a sectional view of the transceiver module, wherein the transceiver module and the socket are in an unlock status;

FIG. 2A is a schematic diagram showing a transceiver module according to a second embodiment of this disclosure;

FIG. 2B is an exploded view of the transceiver module of FIG. 2A;

FIG. 2C is a sectional view of the transceiver module along the line B-B of FIG. 2A, wherein the transceiver module and the socket are in a lock status;

FIG. 2D is a sectional view of the transceiver module, wherein the transceiver module and the socket are in an unlock status;

FIG. 3A is a schematic diagram showing a transceiver module according to a third embodiment of this disclosure;

FIG. 3B is an exploded view of the transceiver module of FIG. 2A;

FIG. 3C is a sectional view of the transceiver module along the line C-C of FIG. 3A, wherein the transceiver module and the socket are in a lock status; and

FIG. 3D is a sectional view of the transceiver module, wherein the transceiver module and the socket are in an unlock status.

### DETAILED DESCRIPTION OF THE INVENTION

The present invention will be apparent from the following detailed description, which proceeds with reference to the accompanying drawings, wherein the same references relate to the same elements.

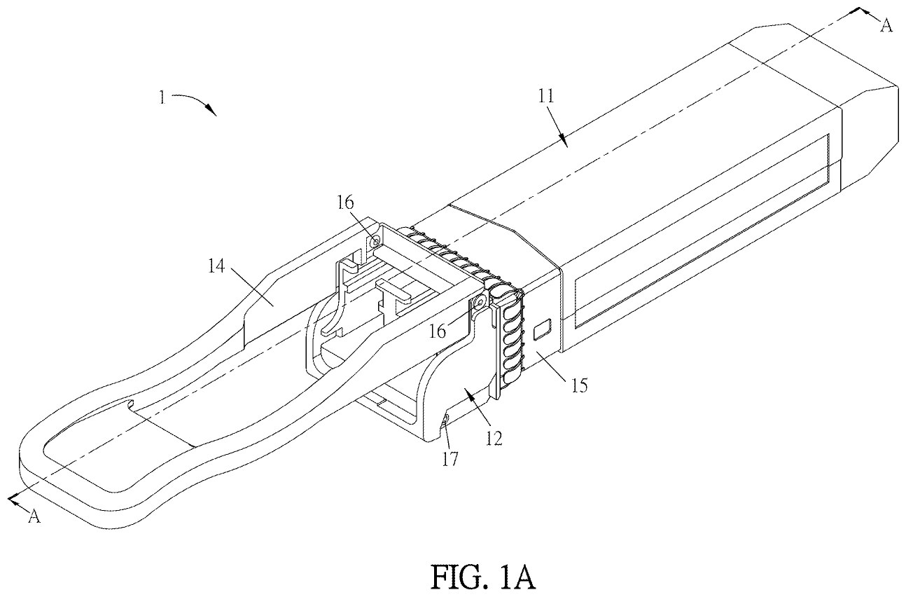

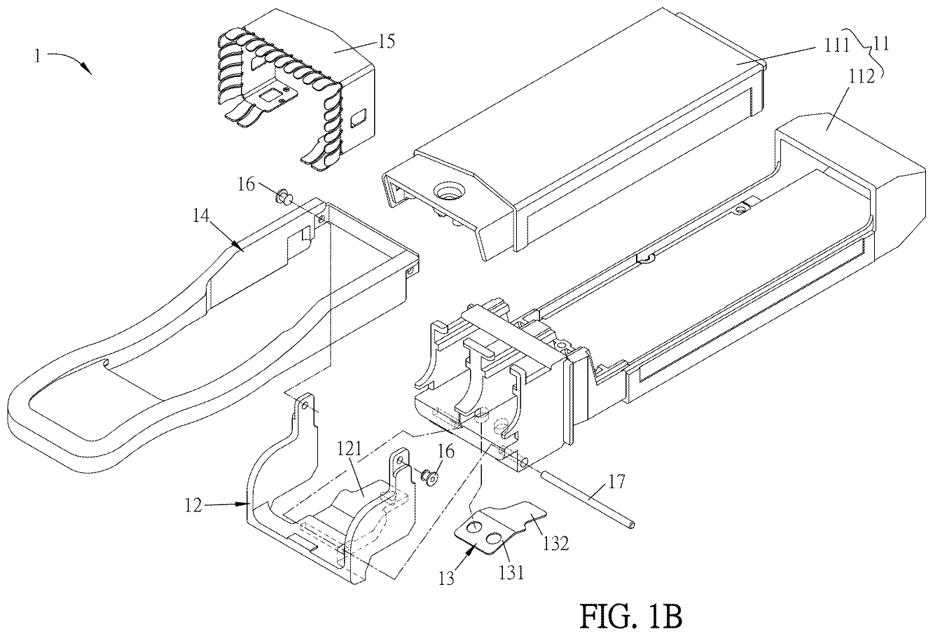

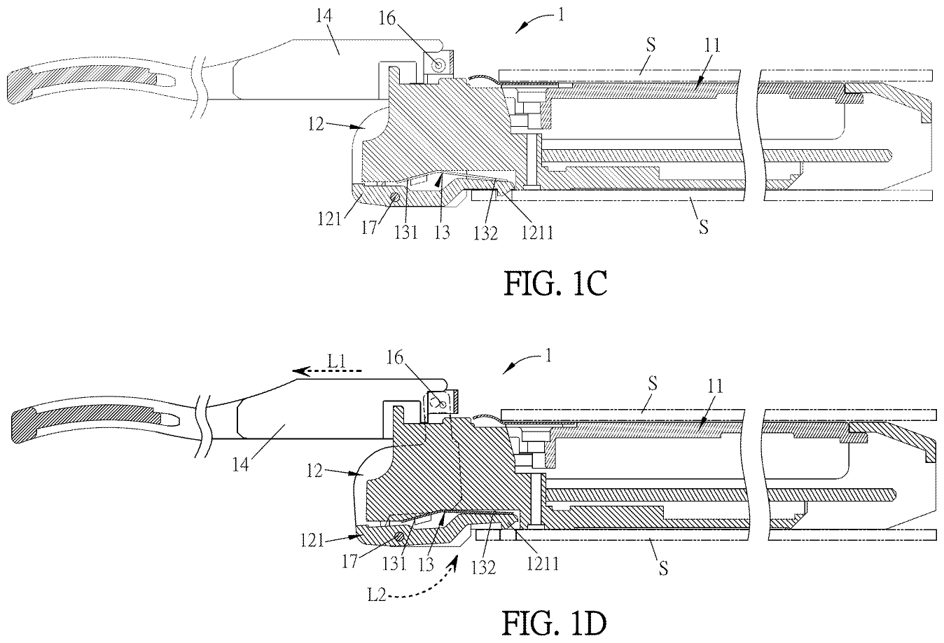

FIG. 1A is a schematic diagram showing a transceiver module 1 according to a first embodiment of this disclosure, and FIG. 1B is an exploded view of the transceiver module 1 of FIG. 1A. Referring to FIGS. 1A and 1B, the transceiver module 1 comprises a housing 11, a latch 12, a springy sheet 13, and a pull tab 14. The latch 12 has a wedging portion 121 and is movably connected to the housing 11. The springy sheet 13 is disposed between the housing 11 and the latch 12. The pull tab 14 is connected to the latch 12. As shown in the drawings, the pull tab 14 is pivotally connected to the latch 12 through a first pivoting member 16, and the latch 12 is movably connected to the housing 11 through a second pivoting member 17.

FIG. 1C is a sectional view of the transceiver module 1 along the line A-A of FIG. 1A, wherein the transceiver module 1 and the socket S are in a lock status. FIG. 1D is a sectional view of the transceiver module 1, wherein the transceiver module 1 and the socket S are in an unlock status. When the pull tab 14 moves from a first pull tab position (see FIG. 1C) to a second pull tab position (see FIG. 1D), the pull tab 14 applies a force to move the latch 12 with relative to the housing 11 and to carry the wedging portion 121 to move from a first wedging position (see FIG. 1C) to a second wedging position (see FIG. 1D) so as to deform the springy sheet 13. When the force applied to the latch 12 by the pull tab 14 is removed, the springy sheet 13 pushes the wedging portion 121 to move from the second wedging position (see FIG. 1D) to the first wedging position (see FIG. 1C). In more detailed, when the pull tab 14 moves from the first pull tab position (see FIG. 1C) to the second pull tab position (see FIG. 1D), the pull tab 14 can drive the latch 12 to move through the first pivoting member 16. In addition, since the latch 12 is connected to the housing 11 through the second pivoting member 17, the latch 12 will be pivotally rotated about the connecting portion with relative to the housing 11, thereby carrying the wedging portion 121 to move from the first wedging position (see FIG. 1C) to the second wedging position (see FIG. 1D) so as to deform the springy sheet 13 (generating a springy force). When the force applied to the latch 12 by the pull tab 14 is removed, the springy force of the springy sheet 13 is released to push the wedging portion 121 to move from the second wedging position (see FIG. 1D) to the first wedging position (see FIG. 1C).

In this embodiment, the springy sheet 13 is a bent sheet as shown in the drawings. The first end 131 of the springy sheet 13 is coupled to the housing 11 by wedging, and the second end 132 of the springy sheet 13 contacts against one side of the wedging portion 121 close to the housing 11. Of course, the springy sheet 13 can be a flat sheet or a curved sheet, and the first end 131 of the springy sheet 13 can be coupled to the housing 11 by interference bonding, locking, screwing, or injection molding. This disclosure is not limited. Alternatively, the first end 131 of the springy sheet 13 may contact against the housing 11, and the second end 132 of the springy sheet 13 may be coupled to the latch 12 by interference bonding, locking, wedging, screwing, or injection molding. To be noted, any arrangement that can dispose the springy sheet 13 between the housing 11 and the latch 12 and allow the wedging portion 121 to push the springy sheet 13 to generate the deformation is acceptable, and this disclosure is not limited.

In this embodiment, the wedging portion 121 comprises a wedging bump 1211, and the wedging bump 1211 is disposed at one side of the wedging portion 121 away from the housing 11. The pull tab 14 is moved from the first pull tab position (see FIG. 1C) to the second pull tab position (see FIG. 1D) by shifting (shown as the arrow L1 of FIG. 1D). When the pull tab 14 moves from the first pull tab position (see FIG. 1C) to the second pull tab position (see FIG. 1D), the pull tab 14 applies a force to move the latch 12 with relative to the housing 11 (shown as the arrow L2 of FIG. 1D) and to carry the wedging portion 121 to move from the first wedging position (see FIG. 1C) to the second wedging position (see FIG. 1D). Accordingly, the wedging bump 1211 is sunk inwardly, so that the transceiver module 1 can be detached from the socket S.

Referring to FIG. 1B, in this embodiment, the housing 11 comprises an upper housing 111 and a lower housing 112. The design of the upper housing 111 and the lower housing 112 can increase the shielding effect for decreasing the electromagnetic interference of transceiver module 1. In practice, the upper housing 111 and the lower housing 112 can be connected by a clipping member 15 so as to form a small form factor pluggable transceiver module.

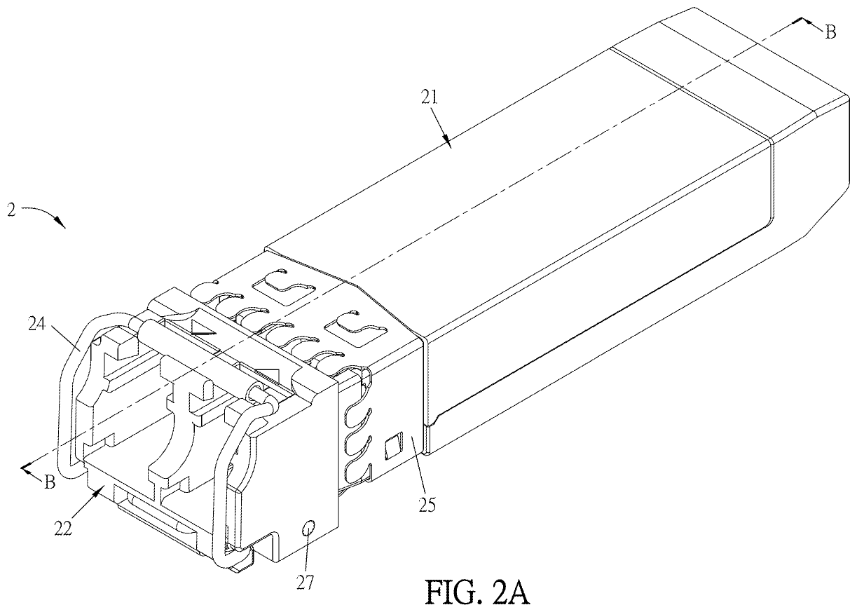

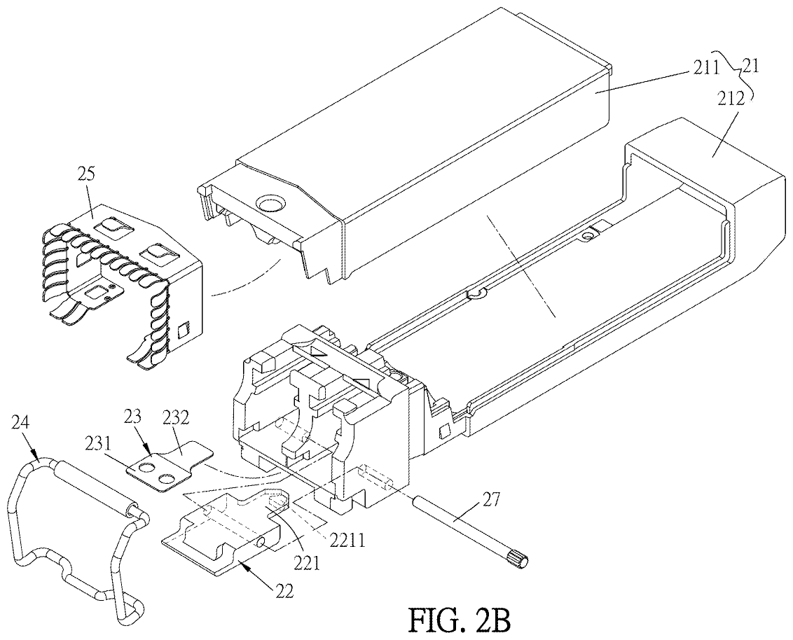

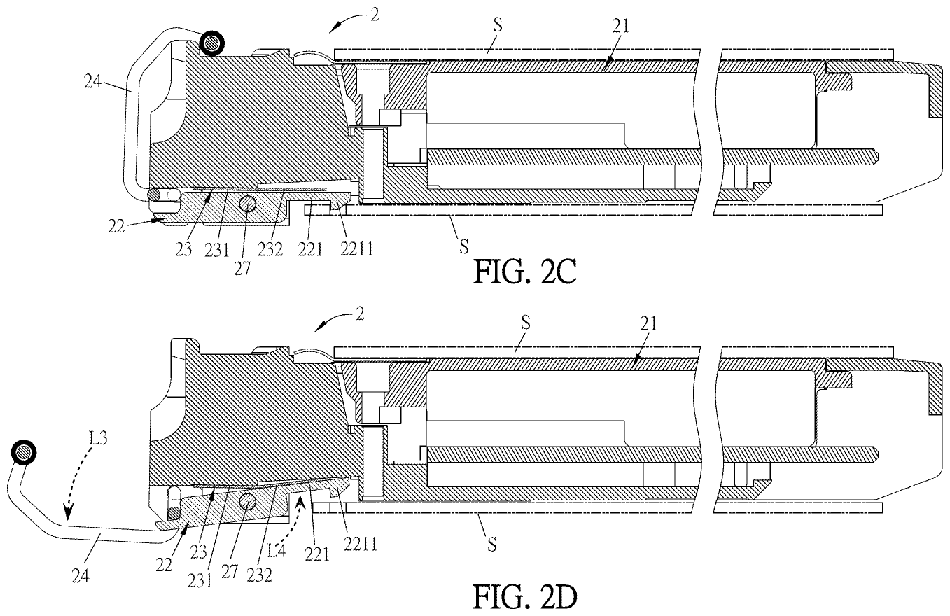

FIG. 2A is a schematic diagram showing a transceiver module 2 according to a second embodiment of this disclosure, and FIG. 2B is an exploded view of the transceiver module 2 of FIG. 2A. Referring to FIGS. 2A and 2B, the transceiver module 2 comprises a housing 21, a latch 22, a springy sheet 23, and a pull tab 24. The latch 22 has a wedging portion 221 and is movably connected to the housing 21. The springy sheet 23 is disposed between the housing 21 and the latch 22. The pull tab 24 is connected to the latch 22. The wedging portion 221 comprises a wedging bump 2211, and the wedging bump 2211 is disposed at one side of the wedging portion 221 away from the housing 21. The features of the transceiver module 2 of the second embodiment are mostly the same as those of the first embodiment, and the difference between the first and second embodiments is in the arrangements of the pull tabs 14 and 24. As shown in FIGS. 2A and 2B, the pull tab 24 is disposed between the housing 21 and the latch 22 and is connected to the latch 22. The latch 22 is movably connected to the housing 21 through a second pivoting member 27.

FIG. 2C is a sectional view of the transceiver module 2 along the line B-B of FIG. 2A, wherein the transceiver module 2 and the socket S are in a lock status. FIG. 2D is a sectional view of the transceiver module 2, wherein the transceiver module 2 and the socket S are in an unlock status. In the second embodiment, the pull tab 24 moves from a first pull tab position (see FIG. 2C) to a second pull tab position (see FIG. 2D) by rotating (shown as the arrow L3 of FIG. 2D). When the pull tab 24 moves from the first pull tab position (see FIG. 2C) to the second pull tab position (see FIG. 2D), the pull tab 24 applies a force to move the latch 22 with relative to the housing 21 (shown as the arrow L4 of FIG. 2D) and to carry the wedging portion 221 to move from a first wedging position (see FIG. 2C) to a second wedging position (see FIG. 2D). Accordingly, the wedging bump 2211 can be sunk inwardly, so the transceiver module 2 can be detached from the socket S. In more detailed, when the pull tab 24 moves from the first pull tab position (see FIG. 2C) to the second pull tab position (see FIG. 2D), the structure of the pull tab 24 can drive the latch 22 to move. In addition, since the latch 22 is connected to the housing 21 through the second pivoting member 27, the latch 22 will be pivotally rotated about the connecting portion with relative to the housing 21, thereby carrying the wedging portion 221 to move from the first wedging position (see FIG. 2C) to the second wedging position (see FIG. 2D) so as to deform the springy sheet 23 (generating a springy force). When the force applied to the latch 22 by the pull tab 24 is removed, the springy force of the springy sheet 23 is released to push the wedging portion 221 to move from the second wedging position (see FIG. 2D) to the first wedging position (see FIG. 2C).

In this embodiment, the springy sheet 23 is a flat sheet as shown in the drawings. The first end 231 of the springy sheet 23 is coupled to the housing 21 by wedging, and the second end 232 of the springy sheet 23 contacts against one side of the wedging portion 221 close to the housing 21. Of course, the springy sheet 23 can be a bent sheet or a curved sheet, and the first end 231 of the springy sheet 23 can be coupled to the housing 21 by interference bonding, locking, screwing, or injection molding. This disclosure is not limited. Alternatively, the first end 231 of the springy sheet 23 may contact against the housing 21, and the second end 232 of the springy sheet 23 may be coupled to the latch 22 by interference bonding, locking, wedging, screwing, or injection molding. To be noted, any arrangement that can dispose the springy sheet 23 between the housing 21 and the latch 22 and allow the wedging portion 221 to push the springy sheet 23 to generate the deformation is acceptable, and this disclosure is not limited.

Referring to FIGS. 2A and 2B, similar to the first embodiment, the housing 21 of the second embodiment also comprises an upper housing 211 and a lower housing 212. In practice, the upper housing 211 and the lower housing 212 can be connected by a clipping member 25 so as to form a small form factor pluggable transceiver module.

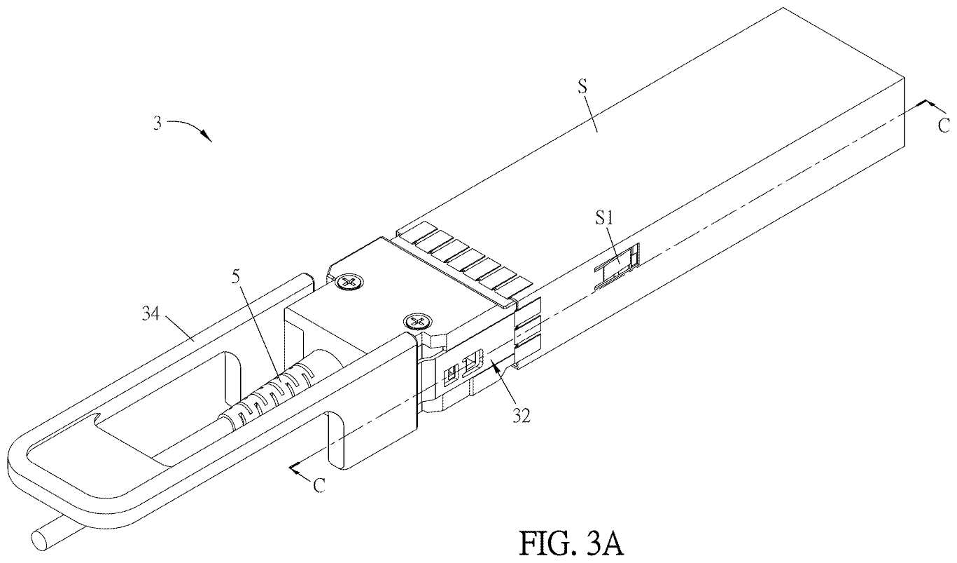

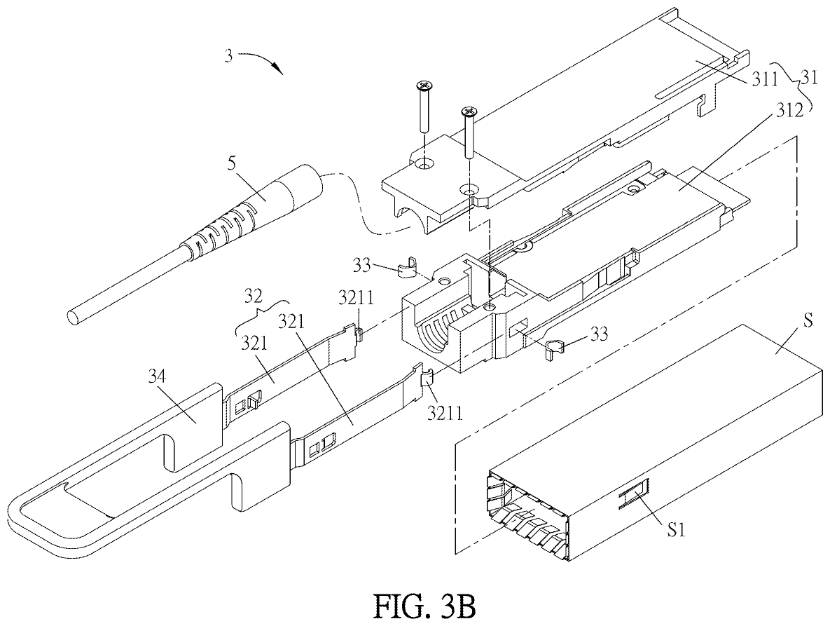

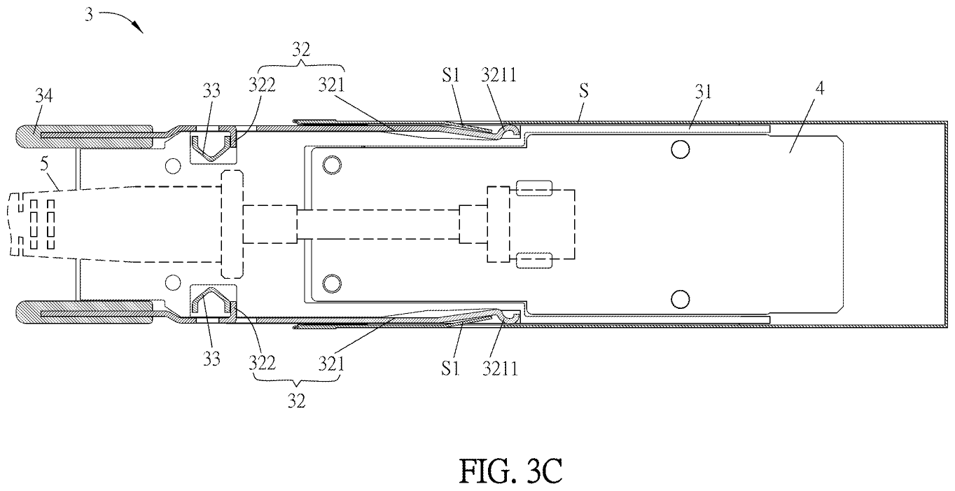

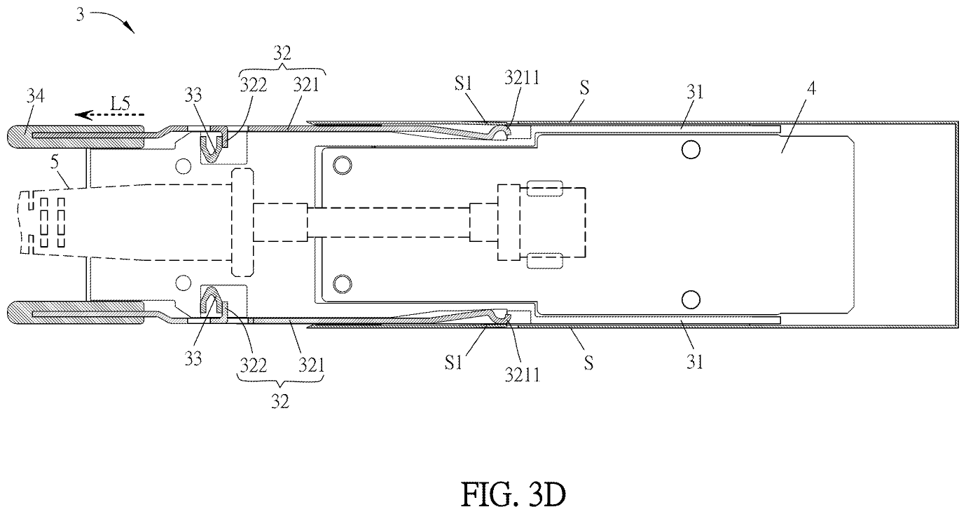

FIG. 3A is a schematic diagram showing a transceiver module 3 according to a third embodiment of this disclosure, and FIG. 3B is an exploded view of the transceiver module 3 of FIG. 3A. Referring to FIGS. 3A and 3B, the transceiver module 3 comprises a housing 31, a latch 32, a springy sheet 33, and a pull tab 34. The latch 32 has a wedging portion 321 and is movably connected to the housing 31. The springy sheet 33 is disposed between the housing 31 and the latch 32. The pull tab 34 is connected to the latch 32. The features of the transceiver module 3 of the third embodiment are mostly the same as those of the first and second embodiments, and the difference between these embodiments is in the wedging portions and springy sheets. In the first and second embodiments, the wedging portion and springy sheet are connected to the bottom of the housing. In the third embodiment, the latch 32 comprises two wedging portions 321, which are connected to two sides of the housing 31. Each wedging portion 321 comprises one wedging bump 3211, and the wedging bump 3211 is disposed at one side of the wedging portion 321 away from the housing 31. Two springy sheets 33 are provided corresponding to the number of the wedging portions 321. Of course, the amounts of the wedging portions 321 and the springy sheets 33 can be adjusted according to the requirement of the user, and this disclosure is not limited.

FIG. 3C is a sectional view of the transceiver module 3 along the line C-C of FIG. 3A, wherein the transceiver module 3 and the socket S are in a lock status. FIG. 3D is a sectional view of the transceiver module 3, wherein the transceiver module 3 and the socket S are in an unlock status. In this embodiment, the pull tab 34 moves from a first pull tab position (see FIG. 3C) to a second pull tab position (see FIG. 3D) by shifting (shown as the arrow L5 of FIG. 3D). When the pull tab 34 moves from the first pull tab position (see FIG. 3C) to the second pull tab position (see FIG. 3D), the pull tab 34 applies a force to move the latch 32 with relative to the housing 31 (shown as the arrow L6 of FIG. 3D) and to carry the wedging portion 321 to move from a first wedging position (see FIG. 3C) to a second wedging position (see FIG. 3D). Accordingly, the wedging bump 3211 can push the limiting portion Si of the socket S outwardly, so that the transceiver module 3 is unlocked and can be detached from the socket S. Meanwhile, the springy sheet 33 is compressed to generate a springy force. When the force applied to the latch 32 by the pull tab 34 is removed, the springy force of the springy sheet 33 is released to push the wedging portion 321 to move from the second wedging position (see FIG. 3D) to the first wedging position (see FIG. 3C).

In this embodiment, the latch 32 further comprises a protrusion 322 extending from the latch 32 toward the housing 31. One end of the springy sheet 33 contacts against the protrusion 322 of the latch 32, and the other end of the springy sheet 33 contacts against the housing 31. In this embodiment, the springy sheet 33 is a curved sheet as shown in the drawings. Of course, the springy sheet 33 can be a bent sheet or a flat sheet, and the two ends of the springy sheet 33 can be coupled to the housing 31 and the protrusion 322 of the latch 32, respectively, by interference bonding, locking, wedging, screwing, or injection molding. This disclosure is not limited. In addition, the latch 32 comprises two protrusions 322 corresponding to the numbers of the wedging portions 321 and the springy sheets 33. Of course, the amounts of the protrusions 322, the wedging portions 321, and the springy sheets 33 can be adjusted according to the requirements of the user, and this disclosure is not limited.

Referring to FIGS. 3A to 3D, in this embodiment, the transceiver module 3 can be a quad small form-factor pluggable transceiver module. The housing 31 can comprise an upper housing 311 and a lower housing 312.

In the above-mentioned first to third embodiments, the transceiver module can further comprise a circuit board and a fiber. Taking the embodiment of FIGS. 3A and 3B as an example, the transceiver module 3 can further comprise a circuit board 4 and a fiber 5. The circuit board 4 is disposed inside the housing 31. When the pluggable transceiver module 3 is plugged in the socket S, the circuit board 4 is electrically connected with the electrical connector of the socket S. The fiber 5 can be inserted into the transceiver module 3 for coupling with the photoelectric conversion circuit of the transceiver module 3.

In summary, the transceiver module of this disclosure comprises a springy sheet having a large contact surface for facilitating the adjustment and increasing the reliability of the transceiver module, thereby making the plug and unplug of the transceiver module easier and thus reducing the repairing and/or adjusting time.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

1. A transceiver module, comprising:
a housing;
a latch having a wedging portion and movably connected to the housing;
a springy sheet, wherein a first end of the springy sheet is coupled to the housing, and a second end of the springy sheet contacts against the latch; and
a pull tab connected to the latch, wherein when the pull tab moves from a first pull tab position to a second pull tab position, the pull tab applies a force to move the latch with relative to the housing and to carry the wedging portion to move from a first wedging position to a second wedging position so as to deform the springy sheet, and when the force applied to the latch by the pull tab is removed, the springy sheet pushes the wedging portion to move from the second wedging position to the first wedging position and causes the pull tab to move from the second pull tab position back to the first pull tab position.

2. The transceiver module of claim 1, wherein the springy sheet is a flat sheet, a bent sheet, or a curved sheet.

3. The transceiver module of claim 1, wherein the first end of the springy sheet is coupled to the housing by interference bonding, locking, wedging, screwing, or injection molding.

4. The transceiver module of claim 1, wherein the pull tab is moved from the first pull tab position to the second pull tab position by shifting or rotating.

5. The transceiver module of claim 1, wherein the wedging portion comprises a wedging bump, and the wedging bump is disposed at one side of the wedging portion away from the housing.

6. The transceiver module of claim 5, wherein the second end of the springy sheet contacts against one side of the wedging portion close to the housing.

7. The transceiver module of claim 5, wherein the latch further comprises a protrusion extending from the latch toward the housing, and the second end of the springy sheet contacts against the protrusion of the latch.

8. A transceiver module, comprising:
a housing;
a latch having a wedging portion and movably connected to the housing;
a springy sheet, wherein a first end of the springy sheet contacts against the housing, and a second end of the springy sheet is coupled to the latch; and
a pull tab connected to the latch, wherein when the pull tab moves from a first pull tab position to a second pull tab position, the pull tab applies a force to move the latch with relative to the housing and to carry the wedging portion to move from a first wedging position to a second wedging position so as to deform the springy sheet, and when the force applied to the latch by the pull tab is removed, the springy sheet pushes the wedging portion to move from the second wedging position to the first wedging position and causes the pull tab to move from the second pull tab position back to the first pull tab position.

9. The transceiver module of claim 8, wherein the springy sheet is a flat sheet, a bent sheet, or a curved sheet.

10. The transceiver module of claim 8, wherein the second end of the springy sheet is coupled to the latch by interference bonding, locking, wedging, screwing, or injection molding.

11. The transceiver module of claim 8, wherein the pull tab is moved from the first pull tab position to the second pull tab position by shifting or rotating.

12. The transceiver module of claim 8, wherein the wedging portion comprises a wedging bump, and the wedging bump is disposed at one side of the wedging portion away from the housing.

13. The transceiver module of claim 12, wherein the second end of the springy sheet is coupled to one side of the wedging portion close to the housing.

14. The transceiver module of claim 12, wherein the latch further comprises a protrusion extending from the latch toward the housing, and the second end of the springy sheet is coupled to the protrusion of the latch.

15. A transceiver module, comprising:
a housing;
a latch having a wedging portion and movably connected to the housing;
a springy sheet disposed between the housing and the latch; and
a pull tab connected to the latch, wherein when the pull tab moves from a first pull tab position to a second pull tab position, the pull tab applies a force to move the latch with relative to the housing and to carry the wedging portion to move from a first wedging position to a second wedging position so as to deform the springy sheet, and when the force applied to the latch by the pull tab is removed, the springy sheet pushes the wedging portion to move from the second wedging position to the first wedging position and causes the pull tab to move from the second pull tab position back to the first pull tab position.

16. The transceiver module of claim 15, wherein the springy sheet is a flat sheet, a bent sheet, or a curved sheet.

17. The transceiver module of claim 15, wherein the pull tab is moved from the first pull tab position to the second pull tab position by shifting or rotating.

18. The transceiver module of claim 15, wherein the wedging portion comprises a wedging bump, and the wedging bump is disposed at one side of the wedging portion away from the housing.

19. The transceiver module of claim 18, wherein one end of the springy sheet contacts against one side of the wedging portion close to the housing.

20. The transceiver module of claim 18, wherein the latch further comprises a protrusion extending from the latch toward the housing, and one end of the springy sheet contacts against the protrusion of the latch.
